(19) United States
(12) Patent Application Publication
(10) Pub. No.: US 2023/0118385 A1
(43) Pub. Date: Apr. 20, 2023

(54) PLATFORM FOR RECOMMENDING MEETING PARTICULARS IN AN ONLINE MEETING TOOL

(71) Applicant: Citrix Systems, Inc., Fort Lauderdale, FL (US)

(72) Inventors: Ke Xu, Nanjing (CN); Jessica Li, Nanjing (CN); Jia Yin, Nanjing (CN); Jie Zhuang, Nanjing (CN)

(21) Appl. No.: 17/451,503

(22) Filed: Oct. 20, 2021

Related U.S. Application Data
(63) Continuation of application No. PCT/CN2021/123751, filed on Oct. 14, 2021.

(51) Int. Cl. H04L 12/18; G06K 9/62

(52) U.S. Cl. CPC H04L 12/1818; H04L 12/1822; H04L 12/1831; G06K 9/6215

(57) ABSTRACT

A system and method for enhancing online meeting creation. A disclosed method includes: receiving a meeting title from a meeting agent, the meeting agent configured to interface with a meeting tool configured to create an online meeting for a user; analyzing the meeting title to identify a set of matching records from a meeting records database; determining a list of recommended attendees based on the set of matching records; and returning the list of recommended attendees to the meeting agent.

### BACKGROUND OF THE DISCLOSURE

Numerous tools exist for scheduling online meetings, such as GotoMeeting®, Zoom®, Teams®, etc. As workforces continue to become more geographically spread out, enterprises are relying more and more on such tools to bring people together. It is not unusual for numerous people in many different locales or even countries to be working on a common project. While these meeting tools provide a simple mechanism for scheduling and conducting meetings, their widespread use can provide various challenges for an enterprise.

### BRIEF DESCRIPTION OF THE DISCLOSURE

Aspects of this disclosure include a platform that will recommend meeting attendees and duration when using on-line meeting tools. When a user scheduling a meeting enters a title into a meeting tool, the platform will automatically recommend a set of selectable attendees based on historical meeting data. In addition to recommending attendees, the platform can also recommend a duration for the meeting and other meeting related details.

A first aspect of the disclosure provides a computing device that includes a memory storing instructions for implementing a meeting service that enhances online meeting creation and a processor coupled to the memory and configured to execute the instructions. The instructions perform processes including receiving a meeting title from a meeting agent, the meeting agent configured to interface with a meeting tool configured to create an online meeting for a user. Once received, analyzing the meeting title to identify a set of matching records from a meeting records database and determining a list of recommended attendees based on the set of matching records. Once determined, forwarding the list of recommended attendees to the meeting agent.

A second aspect of the disclosure provides a method that enhances online meeting creation. The method includes receiving a meeting title from a meeting agent, the meeting agent configured to interface with a meeting tool configured to create an online meeting for a user. Once the title is received, analyzing the meeting title to identify a set of matching records from a meeting records database and determining a list of recommended attendees based on the set of matching records. Once the list is determined, returning the list of recommended attendees to the meeting agent.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative workspace environment configured to provide a recommendation platform that enhances meeting creation, in accordance with an illustrative embodiment.

FIG. 2 depicts a first view of a client workspace for creating an online meeting, in accordance with an illustrative embodiment.

FIG. 3 depicts a second view of a client workspace for selecting a meeting tool, in accordance with an illustrative embodiment.

FIG. 4 depicts a third view of a client workspace displaying a meeting tool interface for selecting recommended attendees, in accordance with an illustrative embodiment.

FIG. 5 depicts a fourth view of a client workspace displaying a meeting tool interface for accepting a recommended duration, in accordance with an illustrative embodiment.

FIG. 6 depicts an illustrative meeting record schema, in accordance with an illustrative embodiment.

FIG. 7 depicts a flow diagram of a recommendation engine process, in accordance with an illustrative embodiment.

FIG. 8 depicts a network infrastructure, in accordance with an illustrative embodiment.

FIG. 9 depicts a computing system, in accordance with an illustrative embodiment.

FIG. 10A is a block diagram of an example system in which resource management services may manage and streamline access by clients to resource feeds (via one or more gateway services) and/or software-as-a-service (SaaS) applications.

FIG. 10B is a block diagram showing an example implementation of the system shown in FIG. 10A in which various resource management services as well as a gateway service are located within a cloud computing environment.

FIG. 10C is a block diagram similar to that shown in FIG. 10B but in which the available resources are represented by a single box labeled “systems of record,” and further in which several different services are included among the resource management services.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for enhancing on-line meeting tools (i.e., “meeting tools”). A recommendation platform is provided that will automatically recommend attendees for an online meeting by analyzing the meeting title. The platform can further recommend a duration of the meeting and other meeting details. In current practice, when scheduling online meetings, the scheduler may not know who the best people are to attend the meeting. Further, the scheduler will typically guess a duration of the meeting, typically in half hour or hour increments. This practice can result in meetings being scheduled with inappropriate attendees and duration times. This in turn can overload people's calendars, waste time, and generate conflicts.

In certain aspects, a recommendation platform is disclosed that uses natural language (NL) processing and machine learning to recommend meeting attendees and a meeting duration based on a meeting title. In various aspects, historical meeting records are analyzed to identify prior meetings with similar subject matter, e.g., based on meeting titles, actual meeting times of similar meetings, attendee participation details (e.g., time spent talking, instances of screen sharing, instances where attendees dropped out of meetings early, etc.), etc.

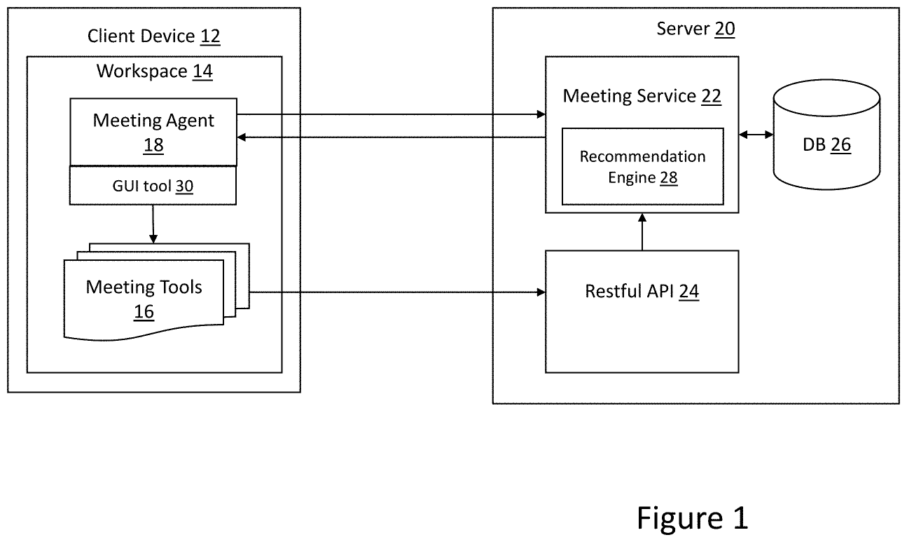

In various illustrative embodiments, the recommendation platform is implemented in a virtual workspace environment, such as that shown in FIG. 1. Illustrative virtual workspace environments include CITRIX® Workspace, available from Citrix System, Inc. of Fort Lauderdale, Fla., which provides an information retrieval service where users can access programs and files from a variety of sources through a central application or a Web browser. In the example shown, a client device 12 includes a virtual workspace 14 that interacts with a server 40 such as a cloud server. The workspace 14 includes one or more selectable meeting tools 16 for scheduling and attending on-line meetings. As noted, illustrative meeting tools 16 may for example include GotoMeeting®, Zoom®, Teams®, etc.

In the depicted embodiment, workspace 14 is further equipped with a meeting agent 18 that interacts with a meeting service 22 on server 20 when a new meeting is being schedule. For example, when a new meeting is created using one of the meeting tools 16, the meeting agent 18 extracts and sends meeting related details to the meeting service 22 as they are entered by a user. A recommendation engine 28 analyzes the meeting related details against meeting records stored in a meeting records database (DB) 26, and returns recommendations (e.g., attendees, duration, etc.) to the meeting agent 18. A graphical user interface (GUI) tool 30 renders the recommendations and allows the user to select recommendations while interacting with the meeting tool 16. The meeting agent 18 is further configured to interface with the meeting tool 16 and automatically loads user selected recommendations into the meeting tool 16.

In one illustrative embodiment, the process begins when a user enters a title into a title field in the meeting tool 16. Once a title is entered, the meeting agent 18 automatically forwards the title to the meeting service 22. Once received, the meeting service 22 deploys a recommendation engine 28 that analyzes the title and fetches similar meetings records (referred to herein as “matching records”) from meeting records DB 26. The matching records are analyzed to determine a list of recommended attendees, which is then forwarded back to the meeting agent 18. Once received, the meeting agent 18 displays (e.g., overlays) the list of recommended attendees using the GUI tool 30. The user is then able to select recommended attendees for the meeting, which then automatically populates an attendee field in the meeting tool 16. At this point, the user can also manually enter their own additional attendees into the attendee field to provide a completed attendee list.

In addition, the recommendation engine 28 also analyzes the matching records to determine a recommended duration for the meeting. The recommended duration may be based on the actual meeting times in the matching records, or any other factors. Once determined, the recommended duration is forwarded back to and displayed by the meeting agent 18, which can be accepted or rejected by the user. If the user accepts the recommended duration, the duration is automatically entered into a duration or end time field in the meeting tool 16 by the meeting agent 18.

In an alternative embodiment, once the attendee list is completed in the meeting tool 16 (i.e., with selected attendees and manually entered attendees), the completed attendee list can be forwarded by the meeting agent 18 back to the meeting service 22. The meeting service 22 can then evaluate the completed attendee list and update the matching records potentially with new matching records from DB 26. The updated set of matching records can then be used to generate the recommended duration for the meeting.

In further embodiments, recommendations for any meeting field can be generated by the recommendation engine 28 based on other captured meeting particulars. For example, recommendations may include recommendations for any field in the meeting tool 16, e.g., a recommended meeting location, a preferred host, proposed exhibits or attachments, meeting tool settings, etc. Captured particulars may likewise include any information entered by the user into any field in the meeting tool, e.g., title, attendees, location, details, etc.

Regardless, after the user completes all desired fields in the meeting tool 16, the user can instruct the meeting tool 16 to send the meeting invitation to the attendee list. Once the meeting is held and completed, the meeting tool 16 generates and provides a new meeting record to a restful application programming interface (API) 24 on the server 20, which forwards the new meeting record to the meeting service 22 for storage in the meeting records DB 26. The new meeting record may for example included a meeting title, attendees, recommend duration, actual duration, user participation details, etc.

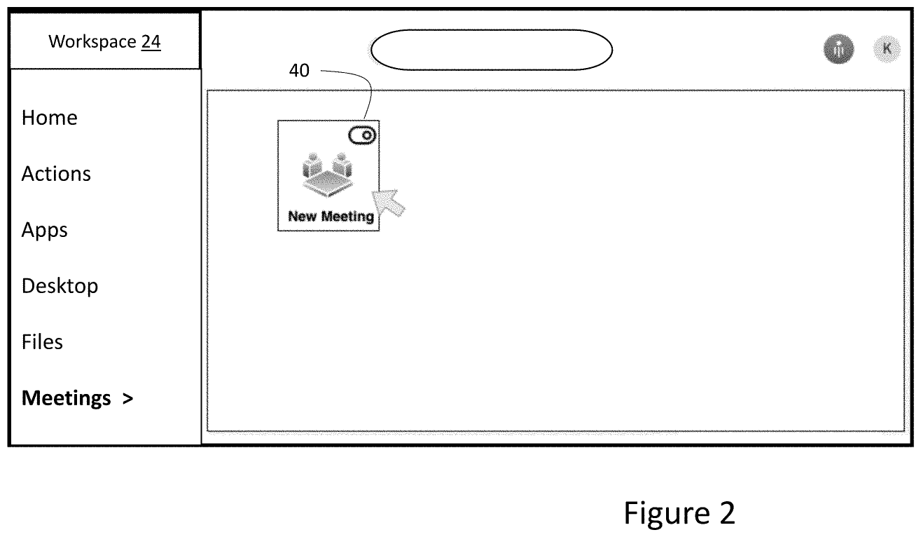

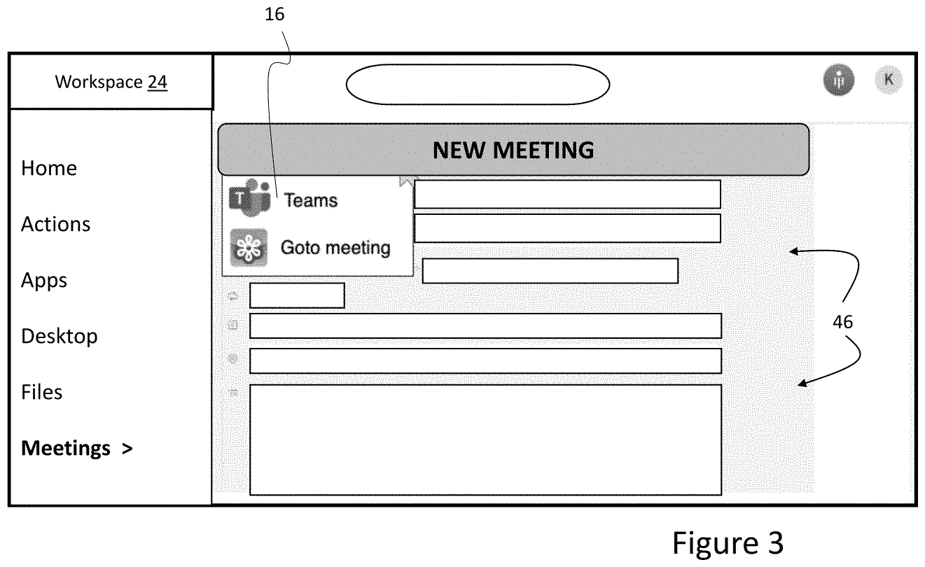

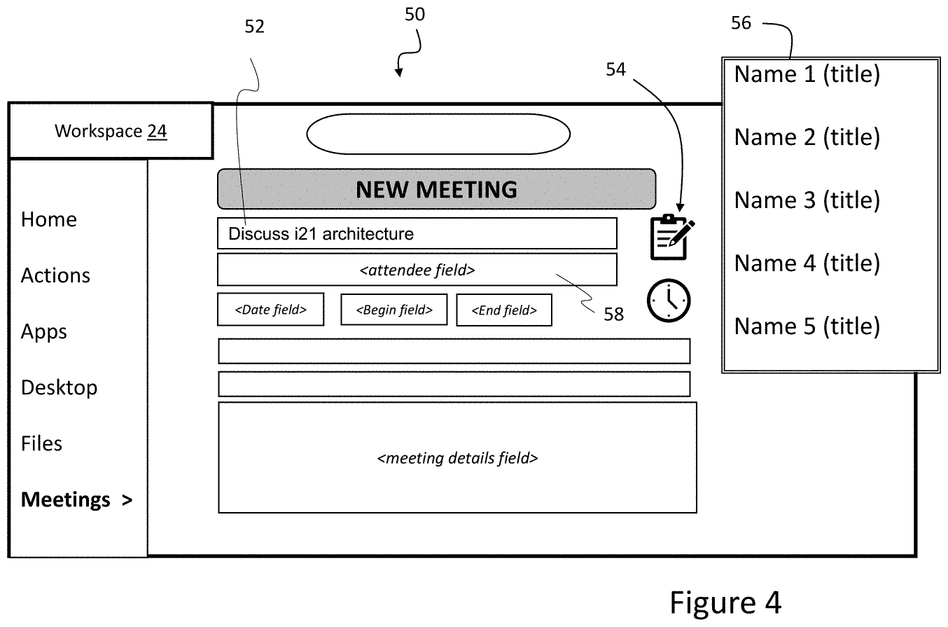

FIGS. 2-5 depict an illustrative workspace 24. FIG. 2 depicts workspace 24 with an icon 40 to create a new meeting. In response to clicking icon 40, a new meeting interface 46 is presented to the user in the workspace 24, such as that shown in FIG. 3. From the new meeting interface, the user can select a meeting tool 16 to create the meeting. Once the meeting tool 16 is selected, a new meeting interface 50 is presented such as that shown in FIG. 4. Interface 50 includes various fields for entering meeting particulars, including a title field 52 in which the user has in this example typed “Discuss i21 architecture.”

In this illustrative embodiment, the user can select an attendee recommendation icon 54 that will cause the meeting agent 18 to capture and forward the title to the meeting service 22 on server 20 (FIG. 1). Alternatively, the title can be forwarded automatically without taking any action, e.g., without selecting icon 54. Regardless, in response to receiving a title, the recommendation engine 28 generates a set of recommended attendees 56, which are forwarded back to the meeting agent 18 and displayed with the meeting interface 50. As shown, the set of recommended attendees 56 includes a list of names and other information such as the job title of each listed name. The user is then able to select names from the list 56 which will cause the attendee field 58 to be automatically populated with the selected names. As noted, the user can also manually enter other attendee names in the attendee field 58.

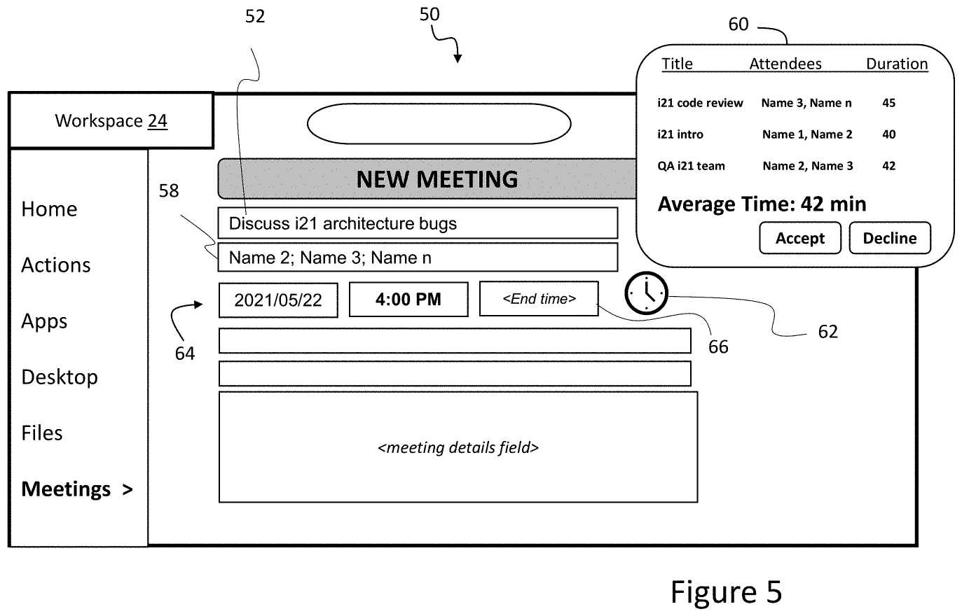

As shown in FIG. 5, once a final attendee list is entered in the attendee field 58, the user can select a date/time recommendation icon 62, which will cause a date and start time 64 to be automatically determined based on calendar availability of the attendees, i.e., 4:00 PM on 2021 May 22 in depicted example. (Note the user could manually enter a date and start time 64.) Additionally, a duration recommendation overlay 60 is displayed with a recommended duration and associated details. As described herein, the recommendation engine 28 (FIG. 1) will calculate a recommended meeting duration by analyzing similar, i.e., matching records, which in this case are shown in overlay 60. In this example, the duration recommendation details show that there are three prior matching meetings with an average duration of 42 minutes, which is the recommended duration using one illustrative approach. In this embodiment, the user can accept or decline the recommendation by selecting a button in the overlay 60. If the user accepts the recommended duration, then the end time field 66 is automatically populated with the calculated end time, i.e., 4:42 PM. As opposed to using a default meeting duration of one hour, this approach potentially saves 18 minutes of time for each of the attendees.

It is understood that the use of the overlay 60 is optional, as the date, begin time and/or end time could be automatically populated in their respective fields without showing the duration recommendation details. Furthermore, it is understood that recommendations for attendees, duration, etc., could be further refined based on additional meeting particulars entered by the user. For example, the user could ender free form meeting details, a location, a specified date, etc., that might result in a different or updated set of recommended attendees and/or duration. Regardless, once the meeting particulars are complete, the meeting invitation can be forwarded to the attendee list via a software as a service API in workspace 24 or server 20.

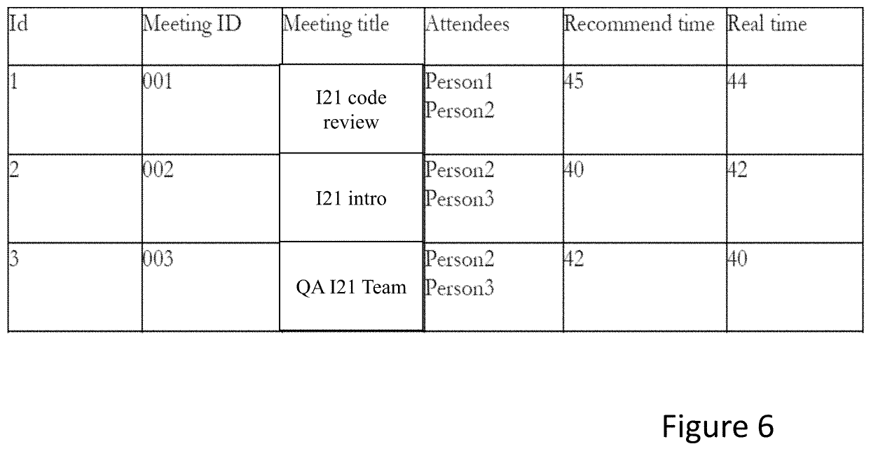

As noted, meeting records DB 26 collects and stores meeting records for completed meetings, which may include recommended duration, actual duration, title, attendees, participation details, etc. FIG. 6 depicts an illustrative database schema for storing meeting records. In this example, each record includes: an Id that provides a sequence number or primary key for accessing a record; a Meeting ID that provides a sequence number for identify a meeting; a Meeting title; Attendees who joined the meeting; the Recommend time which is the duration calculated by the recommendation engine 28; the Real time that was that actual meeting duration. It is understood that the schema could include more or fewer fields, e.g., it could include meeting details, attendee participation information such as which attendees spoke and for how long, which attendees stayed or left the meeting, which attendees shared their screen, etc.

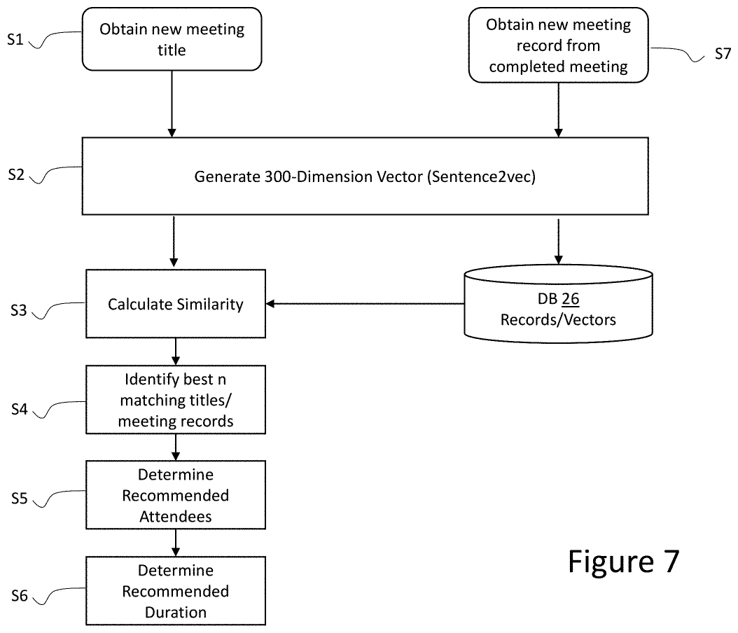

An illustrative process for implementing the recommendation engine 28 is provide in FIG. 7. At S1, a new meeting title is obtained from the meeting agent 18 and forwarded to the recommendation engine 28. At S2, the title is processed by a machine learning tool (e.g., Sentence2vec) that generates a vector representation of the title, e.g., a 300-dimension vector. Sentence2vec is a known machine learning model pretrained to process a sentence (or string of words) and generate a 300-dimension vector. It is understood that Sentence2vec is one possible embodiment, but any natural language and/or machine learning process that converts unstructured data into structured data could be used. At S3, the generated vector is compared with other existing 300-dimension vectors of titles stored in DB 26 using a similarity algorithm. In one approach, a cosine similarity algorithm may be utilized that calculates a similarity score between the generated vector and each of the existing vectors in DB 26. In this case, each existing vector is pre-generated from a title in an associated meeting record using the same natural language/machine learning process. For example, after a meeting is completed, a new meeting record is obtained at S7, and its title is processed at S2 to generate a 300-dimension vector. The new meeting record and resulting vector are then stored in DB 26.

In a typical embodiment, the cosine similarity algorithm can be provided as:

$$\begin{matrix}cos θ = \frac{{\sum }_{i = 1}^{n} ( {A}_{i} \times {B}_{i} )}{\sqrt{{\sum }_{i = 1}^{n} {( {A}_{i} )}^{2}} \times {\sum }_{i = 1}^{n} {( {B}_{i} )}^{2}} \\ = \frac{A \cdot B}{\vert A \vert \times \vert B \vert}\end{matrix}$$

Where A and B are the two vectors being compared and the resulting score is cos θ. In further embodiments, more complex vectors can be generated from other meeting particulars beyond the title, e.g., date, meeting description, meeting location, etc. Regardless, at S4, meeting records having the highest n scoring titles (i.e., the matching records) are identified, i.e., those with highest calculated similarity scores. In a simple case, the engine 28 can simply determine the matching records as those with the top three highest similarity scores. In more advanced embodiments, the set of matching records can vary in number and depend on other factors such as the quality of the matches, the number of attendees in each of the meetings, etc. Regardless, once the matching records are identified, recommended attendees are determined at S5. In a simple approach, all the attendees from the matching records are returned as recommended attendees. In other embodiments, attendees from matching records can be scored and ranked, e.g., based on attendance frequency, participation, etc., and the top attendees can be returned as the recommended attendees. Any only process for determining recommended attendees from the matching records could be used.

At S6, the recommended duration is calculated based on the matching records from S4. In one approach, the average meeting time from the matching records is calculated and returned as the recommended duration. In further embodiments, the recommended duration can involve more complex calculations, e.g., the meeting times from the matching records may be weighted and adjusted, e.g., based on their similarity scores, based on the number of recommended attendees selected by the user, etc.

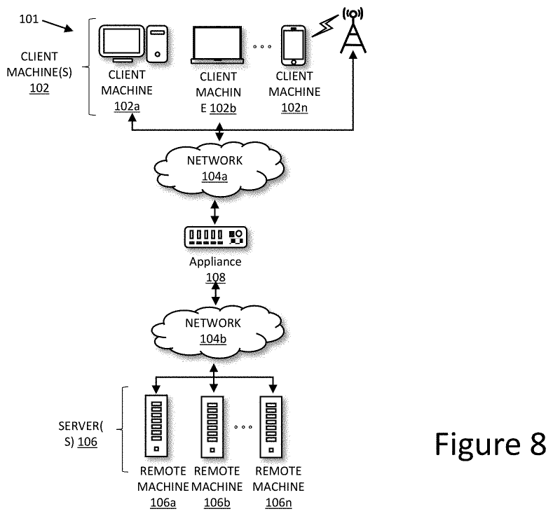

Referring to FIG. 8, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

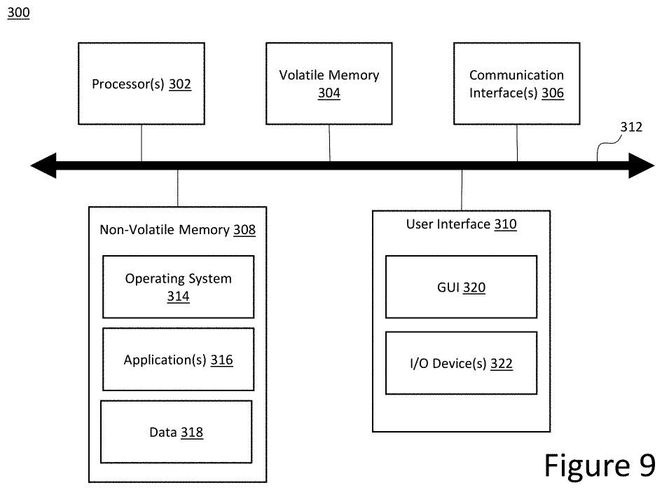

Elements of the described solution may be embodied in a computing system, such as that shown in FIG. 9 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 9 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

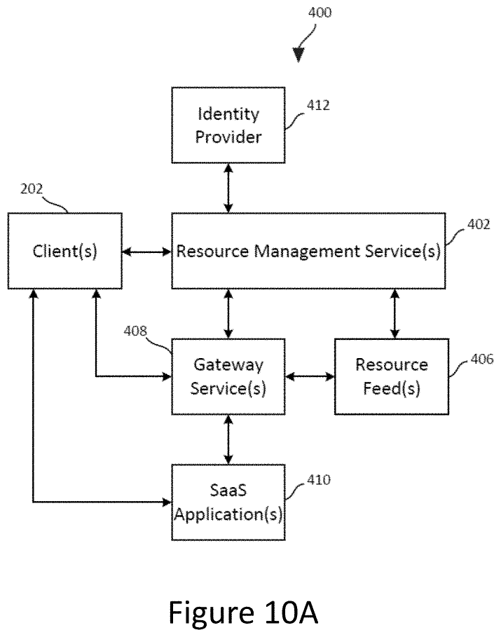

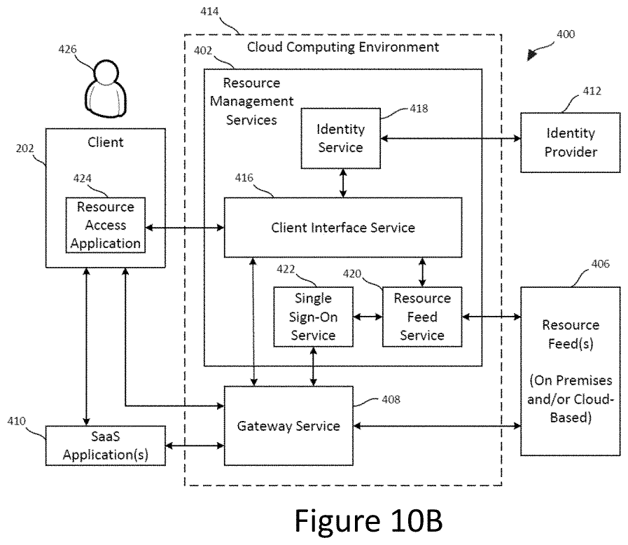

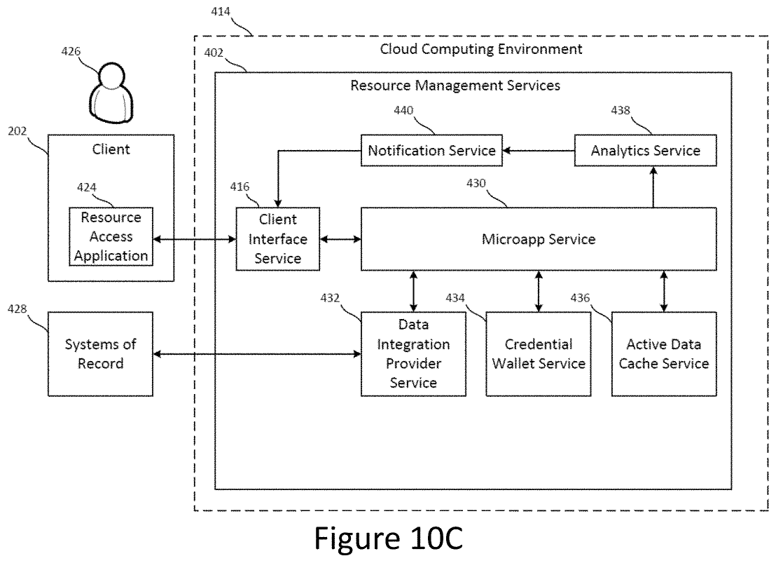

FIG. 10A is a block diagram of an example system 400 in which one or more resource management services 402 may manage and streamline access by one or more clients 202 to one or more resource feeds 406 (via one or more gateway services 408) and/or one or more software-as-a-service (SaaS) applications 410. In particular, the resource management service(s) 402 may employ an identity provider 412 to authenticate the identity of a user of a client 202 and, following authentication, identify one of more resources the user is authorized to access. In response to the user selecting one of the identified resources, the resource management service(s) 402 may send appropriate access credentials to the requesting client 202, and the client 202 may then use those credentials to access the selected resource. For the resource feed(s) 406, the client 202 may use the supplied credentials to access the selected resource via a gateway service 408. For the SaaS application(s) 410, the client 202 may use the credentials to access the selected application directly.

The client(s) 202 may be any type of computing devices capable of accessing the resource feed(s) 406 and/or the SaaS application(s) 410, and may, for example, include a variety of desktop or laptop computers, smartphones, tablets, etc. The resource feed(s) 406 may include any of numerous resource types and may be provided from any of numerous locations. In some embodiments, for example, the resource feed(s) 406 may include one or more systems or services for providing virtual applications and/or desktops to the client(s) 202, one or more file repositories and/or file sharing systems, one or more secure browser services, one or more access control services for the SaaS applications 410, one or more management services for local applications on the client(s) 202, one or more internet enabled devices or sensors, etc. Each of the resource management service(s) 402, the resource feed(s) 406, the gateway service(s) 408, the SaaS application(s) 410, and the identity provider 412 may be located within an on-premises data center of an organization for which the system 400 is deployed, within one or more cloud computing environments, or elsewhere.

FIG. 10B is a block diagram showing an example implementation of the system 400 shown in FIG. 10A in which various resource management services 402 as well as a gateway service 408 are located within a cloud computing environment 414. The cloud computing environment may, for example, include Microsoft Azure Cloud, Amazon Web Services, Google Cloud, or IBM Cloud.

For any of illustrated components (other than the client 202) that are not based within the cloud computing environment 414, cloud connectors (not shown in FIG. 10B) may be used to interface those components with the cloud computing environment 414. Such cloud connectors may, for example, run on Windows Server instances hosted in resource locations and may create a reverse proxy to route traffic between the site(s) and the cloud computing environment 414. In the illustrated example, the cloud-based resource management services 402 include a client interface service 416, an identity service 418, a resource feed service 420, and a single sign-on service 422. As shown, in some embodiments, the client 202 may use a resource access application 424 to communicate with the client interface service 416 as well as to present a user interface on the client 202 that a user 426 can operate to access the resource feed(s) 406 and/or the SaaS application(s) 410. The resource access application 424 may either be installed on the client 202, or may be executed by the client interface service 416 (or elsewhere in the system 400) and accessed using a web browser (not shown in FIG. 10B) on the client 202.

As explained in more detail below, in some embodiments, the resource access application 424 and associated components may provide the user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 424 is launched or otherwise accessed by the user 426, the client interface service 416 may send a sign-on request to the identity service 418. In some embodiments, the identity provider 412 may be located on the premises of the organization for which the system 400 is deployed. The identity provider 412 may, for example, correspond to an on-premises Windows Active Directory. In such embodiments, the identity provider 412 may be connected to the cloud-based identity service 418 using a cloud connector (not shown in FIG. 10B), as described above. Upon receiving a sign-on request, the identity service 418 may cause the resource access application 424 (via the client interface service 416) to prompt the user 426 for the user's authentication credentials (e.g., user-name and password). Upon receiving the user's authentication credentials, the client interface service 416 may pass the credentials along to the identity service 418, and the identity service 418 may, in turn, forward them to the identity provider 412 for authentication, for example, by comparing them against an Active Directory domain. Once the identity service 418 receives confirmation from the identity provider 412 that the user's identity has been properly authenticated, the client interface service 416 may send a request to the resource feed service 420 for a list of subscribed resources for the user 426.

In other embodiments (not illustrated in FIG. 10B), the identity provider 412 may be a cloud-based identity service, such as a Microsoft Azure Active Directory. In such embodiments, upon receiving a sign-on request from the client interface service 416, the identity service 418 may, via the client interface service 416, cause the client 202 to be redirected to the cloud-based identity service to complete an authentication process. The cloud-based identity service may then cause the client 202 to prompt the user 426 to enter the user's authentication credentials. Upon determining the user's identity has been properly authenticated, the cloud-based identity service may send a message to the resource access application 424 indicating the authentication attempt was successful, and the resource access application 424 may then inform the client interface service 416 of the successfully authentication. Once the identity service 418 receives confirmation from the client interface service 416 that the user's identity has been properly authenticated, the client interface service 416 may send a request to the resource feed service 420 for a list of subscribed resources for the user 426.

For each configured resource feed, the resource feed service 420 may request an identity token from the single sign-on service 422. The resource feed service 420 may then pass the feed-specific identity tokens it receives to the points of authentication for the respective resource feeds 406. Each resource feed 406 may then respond with a list of resources configured for the respective identity. The resource feed service 420 may then aggregate all items from the different feeds and forward them to the client interface service 416, which may cause the resource access application 424 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 410 to which the user 426 has subscribed. The lists of local applications and the SaaS applications 410 may, for example, be supplied by resource feeds 406 for respective services that manage which such applications are to be made available to the user 426 via the resource access application 424. Examples of SaaS applications 410 that may be managed and accessed as described herein include Microsoft Office 365 applications, SAP SaaS applications, Workday applications, etc.

For resources other than local applications and the SaaS application(s) 410, upon the user 426 selecting one of the listed available resources, the resource access application 424 may cause the client interface service 416 to forward a request for the specified resource to the resource feed service 420. In response to receiving such a request, the resource feed service 420 may request an identity token for the corresponding feed from the single sign-on service 422. The resource feed service 420 may then pass the identity token received from the single sign-on service 422 to the client interface service 416 where a launch ticket for the resource may be generated and sent to the resource access application 424. Upon receiving the launch ticket, the resource access application 424 may initiate a secure session to the gateway service 408 and present the launch ticket. When the gateway service 408 is presented with the launch ticket, it may initiate a secure session to the appropriate resource feed and present the identity token to that feed to seamlessly authenticate the user 426. Once the session initializes, the client 202 may proceed to access the selected resource.

When the user 426 selects a local application, the resource access application 424 may cause the selected local application to launch on the client 202. When the user 426 selects a SaaS application 410, the resource access application 424 may cause the client interface service 416 request a one-time uniform resource locator (URL) from the gateway service 408 as well a preferred browser for use in accessing the SaaS application 410. After the gateway service 408 returns the one-time URL and identifies the preferred browser, the client interface service 416 may pass that information along to the resource access application 424. The client 202 may then launch the identified browser and initiate a connection to the gateway service 408. The gateway service 408 may then request an assertion from the single sign-on service 422. Upon receiving the assertion, the gateway service 408 may cause the identified browser on the client 202 to be redirected to the logon page for identified SaaS application 410 and present the assertion. The SaaS may then contact the gateway service 408 to validate the assertion and authenticate the user 426. Once the user has been authenticated, communication may occur directly between the identified browser and the selected SaaS application 410, thus allowing the user 426 to use the client 202 to access the selected SaaS application 410.

In some embodiments, the preferred browser identified by the gateway service 408 may be a specialized browser embedded in the resource access application 424 (when the resource application is installed on the client 202) or provided by one of the resource feeds 406 (when the resource application 424 is located remotely), e.g., via a secure browser service. In such embodiments, the SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have the client interface service 416 send the link to a secure browser service, which may start a new virtual browser session with the client 202, and thus allow the user to access the potentially harmful linked content in a safe environment.

In some embodiments, in addition to or in lieu of providing the user 426 with a list of resources that are available to be accessed individually, as described above, the user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 426 of something that requires the user's attention (e.g., approval of an expense report, new course available for registration, etc.).

FIG. 10C is a block diagram similar to that shown in FIG. 10B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 10C may enable the provision of a streamlined resource activity feed and/or notification process for a client 202. In the example shown, in addition to the client interface service 416 discussed above, the illustrated services include a microapp service (or simply “microservice”) 430, a data integration provider service 432, a credential wallet service 434, an active data cache service 436, an analytics service 438, and a notification service 440. In various embodiments, the services shown in FIG. 10C may be employed either in addition to or instead of the different services shown in FIG. 10B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 424 without having to launch the native application. The system shown in FIG. 10C may, for example, aggregate relevant notifications, tasks, and insights, and thereby give the user 426 a dynamic productivity tool. In some embodiments, the resource activity feed may be intelligently populated by utilizing machine learning and artificial intelligence (AI) algorithms. Further, in some implementations, microapps may be configured within the cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 10C, the systems of record 428 may represent the applications and/or other resources the resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 402, and in particular the data integration provider service 432, may, for example, support REST API, JSON, OData-JSON, and 6ML. As explained in more detail below, the data integration provider service 432 may also write back to the systems of record, for example, using OAuth2 or a service account.

In some embodiments, the microapp service 430 may be a single-tenant service responsible for creating the microapps. The microapp service 430 may send raw events, pulled from the systems of record 428, to the analytics service 438 for processing. The microapp service may, for example, periodically pull active data from the systems of record 428.

In some embodiments, the active data cache service 436 may be single-tenant and may store all configuration information and microapp data. It may, for example, utilize a per-tenant database encryption key and per-tenant database credentials.

In some embodiments, the credential wallet service 434 may store encrypted service credentials for the systems of record 428 and user OAuth2 tokens.

In some embodiments, the data integration provider service 432 may interact with the systems of record 428 to decrypt end-user credentials and write back actions to the systems of record 428 under the identity of the end-user. The write-back actions may, for example, utilize a user's actual account to ensure all actions performed are compliant with data policies of the application or other resource being interacted with.

In some embodiments, the analytics service 438 may process the raw events received from the microapps service 430 to create targeted scored notifications and send such notifications to the notification service 440.

Finally, in some embodiments, the notification service 440 may process any notifications it receives from the analytics service 438. In some implementations, the notification service 440 may store the notifications in a database to be later served in a notification feed. In other embodiments, the notification service 440 may additionally or alternatively send the notifications out immediately to the client 202 as a push notification to the user 426.

In some embodiments, a process for synchronizing with the systems of record 428 and generating notifications may operate as follows. The microapp service 430 may retrieve encrypted service account credentials for the systems of record 428 from the credential wallet service 434 and request a sync with the data integration provider service 432. The data integration provider service 432 may then decrypt the service account credentials and use those credentials to retrieve data from the systems of record 428. The data integration provider service 432 may then stream the retrieved data to the microapp service 430. The microapp service 430 may store the received systems of record data in the active data cache service 436 and also send raw events to the analytics service 438. The analytics service 438 may create targeted scored notifications and send such notifications to the notification service 440. The notification service 440 may store the notifications in a database to be later served in a notification feed and/or may send the notifications out immediately to the client 202 as a push notification to the user 426.

In some embodiments, a process for processing a user-initiated action via a microapp may operate as follows. The client 202 may receive data from the microapp service 430 (via the client interface service 416) to render information corresponding to the microapp. The microapp service 430 may receive data from the active data cache service 436 to support that rendering. The user 426 may invoke an action from the microapp, causing the resource access application 424 to send that action to the microapp service 430 (via the client interface service 416). The microapp service 430 may then retrieve from the credential wallet service 434 an encrypted Oauth2 token for the system of record for which the action is to be invoked, and may send the action to the data integration provider service 432 together with the encrypted Oath2 token. The data integration provider service 432 may then decrypt the Oath2 token and write the action to the appropriate system of record under the identity of the user 426. The data integration provider service 432 may then read back changed data from the written-to system of record and send that changed data to the microapp service 430. The microapp service 432 may then update the active data cache service 436 with the updated data and cause a message to be sent to the resource access application 424 (via the client interface service 416) notifying the user 426 that the action was successfully completed.

In some embodiments, in addition to or in lieu of the functionality described above, the resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 402 may, for example, parse these requests and respond because they are integrated with multiple systems on the back-end. In some embodiments, users may be able to interact with the virtual assistance through either the resource access application 424 or directly from another resource, such as Microsoft Teams. This feature may allow employees to work efficiently, stay organized, and deliver only the specific information they're looking for.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A computing device, comprising:
a memory storing instructions for implementing a meeting service that enhances online meeting creation; and
a processor coupled to the memory and configured to execute the instructions to perform processes including:
receiving a meeting title from a meeting agent, the meeting agent configured to interface with a meeting tool configured to create an online meeting for a user;
analyzing the meeting title to identify a set of matching records from a meeting records database;
determining a list of recommended attendees based on the set of matching records; and
forwarding the list of recommended attendees to the meeting agent.

2. The computing device of claim 1, further comprising determining and returning a recommended meeting duration to the meeting agent based on the set of matching records.

3. The computing device of claim 1, wherein the meeting agent runs on a virtual workspace configured for the user, the virtual workspace having access to at least one meeting tool configured to schedule and implement online meetings among users.

4. The computing device of claim 3, wherein the set of matching records are identified by calculating a similarity score between the meeting title and a set of prior meeting titles obtained from the meeting records database.

5. The computing device of claim 4, wherein the meeting title and each prior meeting title are converted to a vector format with a machine learning tool, and each similarity score is calculated with a cosine similarity algorithm that operates on a pair of vectors.

6. The computing device of claim 5, wherein the list of recommended attendees includes a set of attendees that attended prior meetings in the set of matching records.

7. The computing device of claim 2, wherein the recommended meeting duration is obtained by averaging an actual duration for prior meetings in the set of matching records.

8. The computing device of claim 7, wherein the recommended meeting duration is further refined based on weights assigned to the prior meetings.

9. The computing device of claim 3, wherein the meeting service is further configured to obtain post-meeting data from the meeting tool and store the post-meeting data as a new meeting record in the meeting records database.

10. The computing device of claim 3, wherein the meeting service is further configured to deploy the meeting agent to the virtual workspace of the user, the meeting agent being configured to:
capture and forward the meeting title entered into a meeting tool interface to the meeting service;
display the list of recommended attendees with the meeting tool interface; and
display a recommended meeting duration with the meeting tool interface.

11. A method that enhances online meeting creation, the method comprising:
receiving a meeting title from a meeting agent, the meeting agent configured to interface with a meeting tool configured to create an online meeting for a user;
analyzing the meeting title to identify a set of matching records from a meeting records database;
determining a list of recommended attendees based on the set of matching records; and
returning the list of recommended attendees to the meeting agent.

12. The method of claim 11, further comprising determining and returning a recommended meeting duration to the meeting agent based on the set of matching records.

13. The method of claim 11, wherein the meeting agent runs on a virtual workspace configured for the user, the virtual workspace having access to at least one meeting tool configured to schedule and implement online meetings among users.

14. The method of claim 13, wherein the set of matching records are identified by calculating a similarity score between the meeting title and a set of prior meeting titles obtained from the meeting records database.

15. The method of claim 14, wherein the meeting title and each prior meeting title are converted to a vector format with a machine learning tool, and each similarity score is calculated with a cosine similarity algorithm that operates on a pair of vectors.

16. The method of claim 15, wherein the list of recommended attendees includes a set of attendees that attended prior meetings in the set of matching records.

17. The method of claim 12, wherein the proposed meeting duration is obtained by averaging an actual duration for each prior meeting in the set of matching records.

18. The method of claim 17, wherein the proposed meeting duration is further refined based on weights assigned to the prior meetings.

19. The method of claim 13, further comprises obtaining post-meeting data from the meeting tool and storing the post-meeting data as a new meeting record in the meeting records database.

20. The method of claim 13, further comprising deploying the meeting agent to the virtual workspace of the user, the meeting agent being configured to:
capture and forward the meeting title entered into a meeting tool interface to a meeting service;
display the list of recommended attendees with the meeting tool interface; and
display a recommended meeting duration with the meeting tool interface.
